(19) United States
(12) Patent Application Publication
(10) Pub. No.: US 2005/0168427 A1
(43) Pub. Date: Aug. 4, 2005

(54) Generation of compensatory dataramps in lssh liquid crystal displays

(75) Inventor: Philip Odom, Vancouver, WA (US)

Correspondence Address: KLARQUIST SPARKMAN, LLP, 121 SW SALMON STREET, SUITE 1600, PORTLAND, OR, 97204, US

(73) Assignee: Iljin Diamond Co., Ltd.

(21) Appl. No.: 11/051,250

(22) Filed: Feb. 4, 2005

Related U.S. Application Data
(63) Continuation of application No. PCT/US03/24955, filed on Aug. 7, 2003.
(60) Provisional application No. 60/402,212, filed on Aug. 9, 2002.

(51) Int. Cl. G09G 3/36

(52) U.S. Cl. 345/98

(57) ABSTRACT

The transfer function of an LCD display is selected based on electro-optic response values stored in a memory and supplied to a DATARAMP generator. The electro-optic response values are produced by applying a series of different DATARAMPs corresponding to display gray levels, and recording the associated electro-optic response. The measured response can be combined with a gamma value or other selected display characteristic and stored in memory for use in DATARAMP generation.

### CROSS-REFERENCE TO RELATED APPLICATIONS

This application claims priority from U.S. Provisional Patent Application No. 60/402,212, filed Aug. 9, 2002, and that is incorporated herein by reference.

### TECHNICAL FIELD

The disclosure pertains to projection displays using liquid crystals.

### BACKGROUND

Display users continue to demand accurate and pleasing display of images from a variety of sources. For example, computer graphics, video, and still images should all be displayed with appropriate color rendition. In order to provide acceptable displays, most displays are designed to exhibit a specific transfer function that describes the relationship between video signal level, typically an analog or digital voltage, and display brightness. The transfer function is frequently expressed in terms of an input gray level gᵢₙ and an output gray level as gₒᵤₜ as gₒᵤₜ=gᵢₙ^{γ}, wherein γ is a constant. Gray levels typically are between 0 and 1. The value of γ can be selected based on the images to be displayed. For example, for NTSC broadcast images, a value of about 2.22 is typically selected, while for computer displays, a value of 2.5 is typically selected. Methods and apparatus for measuring electro-optic response and configuring liquid crystal displays to produce a selected response based on such measured responses are needed.

### SUMMARY

Methods of determining an electro-optic (EO) response of a liquid crystal display (LCD) comprise applying a plurality of DataRamp waveforms associated with a corresponding plurality of gray levels to the LCD, and recording values of an optical property of the LCD associated with the plurality of waveforms. In some representative examples, the optical property is LCD transmission. In additional examples, at least one of the DataRamp waveforms has a maximum value greater than a value associated with an LCD black value.

Measurement systems for determining LCD EO response comprise an illuminator configured to direct an illumination beam to an LCD and an optical receiver configured to receive the illumination beam from the LCD. An LCD driver is configured to apply a series of DataRamp voltages to the LCD, wherein the DataRamp voltages are associated with gray values. In representative examples, the DataRamp voltages include linear portions associated with corresponding gray values.

Display drivers comprise a video input configured to receive an image signal and a memory configured to store a set of values associated with a composite transfer function. A DataRamp generator is configured to produce a DataRamp waveform based on the composite transfer function values stored in the memory and to deliver the DataRamp waveform to a display. In additional examples, a display driver input is configured to receive a gamma value, and a memory is configured to store an LCD electro-optic response. A processor is configured to produce composite transfer function values based on the stored electro-optic response and the gamma value.

Liquid crystal display systems comprise at least one liquid crystal display (LCD) and a display driver configured to supply a DataRamp waveform to the LCD, wherein the display driver generates the DataRamp waveform based on transfer function values stored in a memory.

Display processors comprise a memory configured to store values associated with a composite transfer function for a liquid crystal display and a waveform generator configured to produce a data ramp waveform based on the stored values. In additional examples, an input is configured to receive an indication of a gamma correction value, and the memory is configured to store values associated with a gamma-corrected composite transfer function. In further representative examples, a gamma-selector is configured to select a gamma value and a gamma correction processor is configured to produce values associated with a gamma-corrected composite transfer function and direct the values to the memory. In other examples, the memory is configured to store an LCD electro-optic (EO) response, and the gamma-corrected composite transfer function is based on the stored EO response.

Liquid crystal display systems comprise an active matrix liquid crystal display (LCD) and an optical system configured to display an image based on the active matrix LCD. A memory is configured to store a composite transfer function of the LCD and a waveform generator is configured to produce a data ramp waveform based on the stored composite transfer function. In other examples, the memory is configured to store an electro-optic response of the LCD, and a processor is configured to generate composite transfer function values based on the stored electro-optic response. In additional examples, the processor is configured to receive a value of gamma and to generate composite transfer function values based on the value of gamma. In further examples, LCDs associated with red, green, and blue color channels are provided, and the memory is configured to store composite transfer functions associated with the red, green, and blue color channels. The waveform generator is configured to product data ramp waveforms associated with the red, green, and blue color channels. In additional examples, the memory is configured to store electro-optic responses associated with the red, green, and blue color channels. In other examples, the processor is configured to receive a value of gamma and to generate composite transfer function values based on the value of gamma.

Display methods comprise obtaining an electro-optic response of an active matrix liquid crystal display. A data ramp waveform is generated based on the electro-optic response.

These and other examples are described below with reference to the accompanying drawings.

### BRIEF DESCRIPTION OF THE DRAWINGS

FIG. 1 is a schematic diagram illustrating a portion of a liquid crystal display (LCD) configured to provide pixel values based on Ramp and DATARAMP voltages.

FIG. 2 is a schematic diagram illustrating a system for measuring electro-optic (EO) response of an LCD.

FIG. 3 is a graph of a linear DATARAMP waveform and test DATARAMP waveforms showing waveform voltages as a function of time.

FIGS. 4A-4B illustrate an EO curve prior to and after truncation at a maximum and a minimum transmission.

FIG. 4C illustrates an EO curve associated with an inverse of the EO curve of FIG. 4B corresponding to γ=1.

FIG. 4D illustrates a transfer function associated with γ=2.5.

FIG. 4E illustrates a composite transfer function based on a combination of the transfer function of FIG. 4D and the inverted EO curve of FIG. 4C.

FIG. 5 is a schematic diagram of an LCD display system configured to produce gamma corrected images.

### DETAILED DESCRIPTION

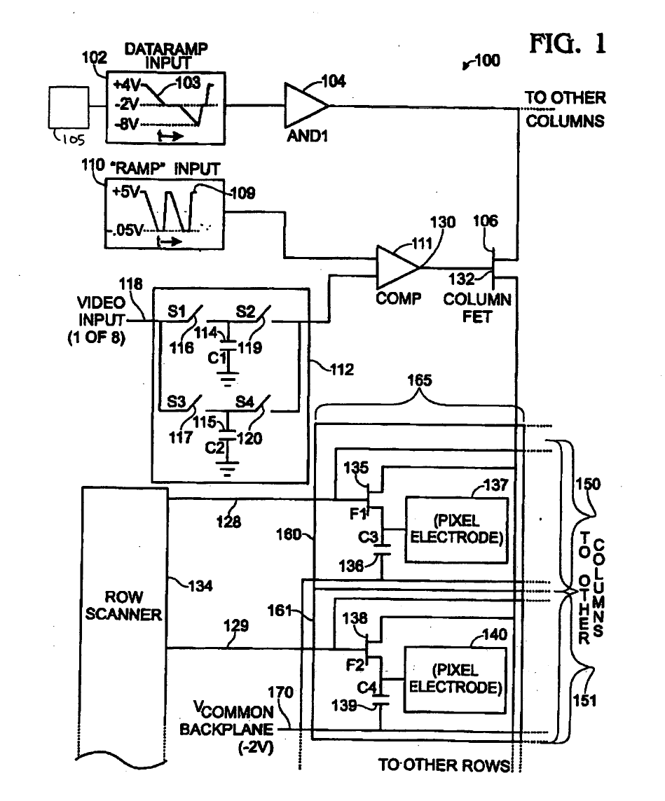

With reference to FIG. 1, a display system 100 includes pixels arranged in one or more rows and one or more columns. FIG. 1 shows only a column 165 and rows 150, 151 that include representative pixels 160, 161, and other pixels, and rows and columns of pixels are not shown. A typical display system includes 200-2000 rows and 200-2000 columns of pixels. The pixels 160, 161 include FETs 135, 138, pixel capacitors 136, 139, and pixel electrodes 137, 140, respectively. The pixel electrodes 137, 140 are situated to provide image dependent pixel voltages to a liquid crystal or other display element with respect to a voltage applied to a backplane electrode 170 that is common to some or all pixels.

A DATARAMP source 102 supplies a DATARAMP voltage, such as a time-dependent voltage 103 to a buffer 104. The DATARAMP voltage can be configured based on a control signal or stored display values provided by a DATARAMP controller 105. The buffered DATARAMP voltage is then delivered to a series of column FETs, such as the exemplary column FET 106. The display system 100 typically includes additional column FETs corresponding to each column of pixels. A RAMP source 110 provides a RAMP voltage, such as a time-dependent voltage 109, to a comparator 111 that also receives voltages associated with image picture elements (pixels) from a sample and hold (S/H) module 112. The S/H module 112 includes sample capacitors 114, 115 that receive image voltages from a video input 118 from a video source or other image source (not shown in FIG. 1) via sample input switches 116, 117. The module 112 also includes sample output switches 119, 120 corresponding to sample capacitors 114, 115. The switches 116, 117, 119, 120 are generally configured so that one of the capacitors 114, 115 charges to a sample voltage corresponding to a pixel voltage via the corresponding switch 116, 117, respectively, while a pixel voltage stored on the other of the capacitors 114, 115 is delivered to the comparator 111 via the corresponding switch 119, 120. As a specific example, the switch 116 is closed to permit the capacitor 114 to charge and the switch 120 is closed to permit the voltage on the capacitor 115 to be delivered to the comparator 111. The switches 117, 119 are open. After charging the capacitor 114 and delivery of the voltage on the capacitor 115 to the comparator 111 is complete, the switch states are reversed so that the capacitor 115 charges to a pixel voltage corresponding to another pixel and the sample voltage on the capacitor 114 is delivered to the comparator 111. The module 112 includes the sample capacitors 114, 115 that acquire and store pixel voltages for pixels in a single column and additional modules can be provided for the remaining columns. In a representative example, the display columns are divided into eight groups and eight video inputs (such as the video input 118) are sequentially switched to sample and hold modules associated with the columns. For example, a first video input is sequentially switched to sample and hold modules for columns 1, 9, 17, . . . , a second video input is sequentially switched to sample and hold modules for columns 2, 10, 18, . . . , and other video inputs are similarly switched. For convenience, only one sample and hold module is shown in FIG. 1. The configuration of FIG. 1 can be referred to as a line scan, sample and hold (LSSH) system as pixel values for a line (a row) of pixels based on an input video signal are stored in corresponding sample capacitors and then transferred to pixels using the DATARAMP waveform.

A DATARAMP waveform can be selected based on liquid crystal transmission as a function of applied voltage, also referred to herein as electro-optic (EO) response. EO response generally depends on illumination wavelength, and EO response for a particular device is measured using an appropriate illumination wavelength. Typically, measurements are made at one or more of red, green, or blue wavelength ranges. Transmission also depends on a selection and orientation of polarizers, and polarizer effects are generally included in EO response as used herein.

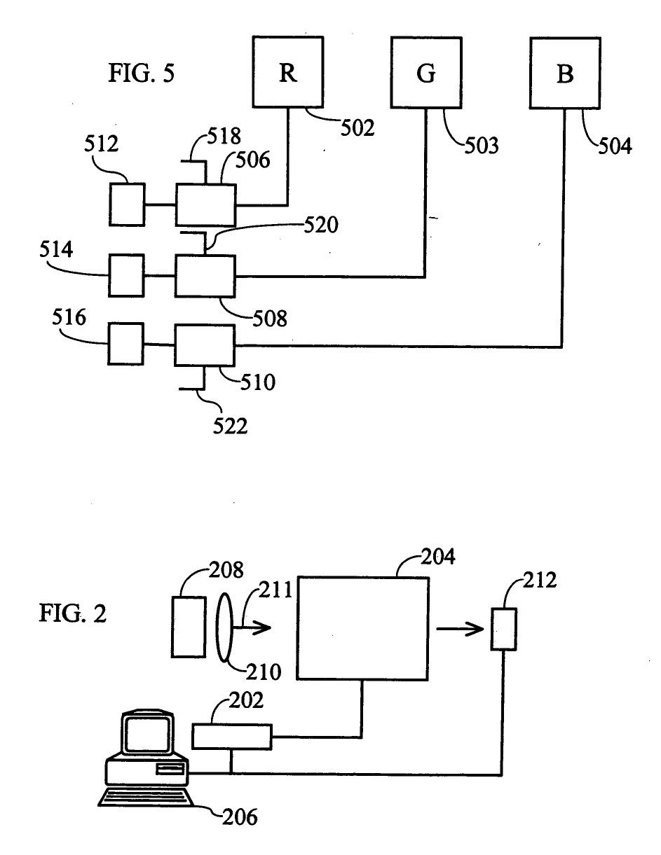

The EO response of a selected liquid crystal display panel (LCD) can be measured using an apparatus illustrated in FIG. 2. An LCD driver 202 is configured to control an LCD 204, typically with drive voltages and timings so that display flicker is reduced or minimized. The LCD driver is also in communication with a personal computer 206 or other device that is configured to deliver correction values associated with, for example, column-to-column uniformity correction. Column correction prior to EO response measurement typically permits EO response to be measured more accurately. An illumination source 208 and an optical system 210 are configured to illuminate the LCD 204 with an optical beam 211, and an optical receiver system 212 is configured to receive the illumination beam from the LCD 204. The optical system 210 can include lenses for optical beam shaping and color filters, polarizers, or other optical components. The optical receiver can be a single detector or a detector array. An integrating sphere or similar apparatus can also be included.

In a representative example, the LCD driver 202 is configured to provide a DATARAMP waveform that ramps linearly from 0 V to a maximum test voltage that is greater than a voltage associated with a nominally black display value. A duration of an active portion of the DATARAMP waveform is approximately the same as an active portion of a RAMP waveform so that a voltage associated with a selected gray level can be applied to one or more pixels. The LCD driver is configured to write one or more display pixels with a plurality of video gray levels, and typically, the entire LCD or a substantial portion thereof is written to the same gray level and the transmission of the LCD measured. A number of gray levels can be selected based on LCD response, and typically not all gray levels are used to characterize a display. For example, in an 8-bit display, there are 256 gray levels, but only some of these levels are generally used. Gray levels can be associated with voltages based on the DATARAMP waveform. Transmission can be scaled so that a most transmissive measurement is associated with a value “1” and a least transmissive measurement is associated with a value “0.” Other transmission scalings are also possible.

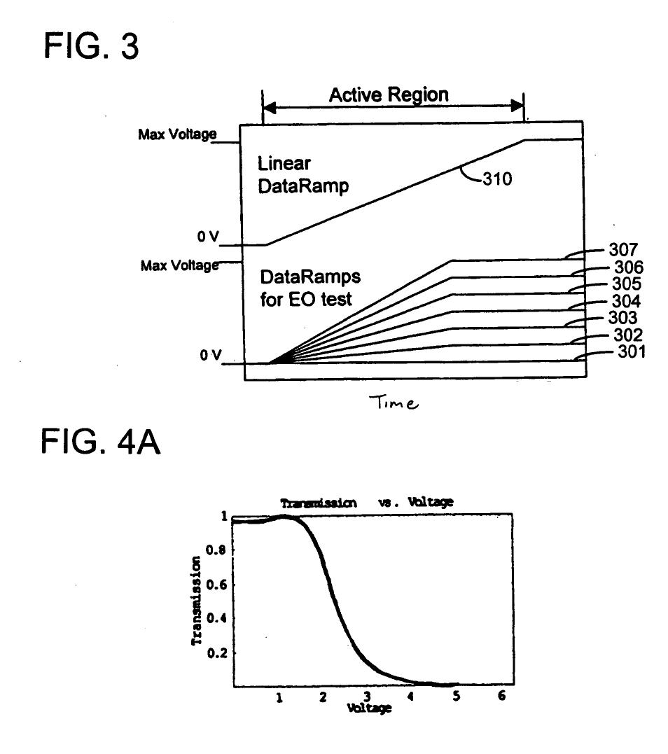

An LCD EO curve can also be measured by varying the DATARAMP waveform so that a maximum (black) voltage varies, and video data delivered to the LCD is associated with this maximum (black) voltage. For each gray level, an appropriate “maximum black” DATARAMP voltage is applied, LCD transmission is measured. By varying the DATARAMP waveform, a video voltage that is associated with a single gray level can be used. FIG. 3 shows a series of DATARAMP waveforms 301-307 that can be used with a fixed gray level video signal (typically a maximum ‘black’ voltage). A linear DATARAMP waveform 310 is also shown.

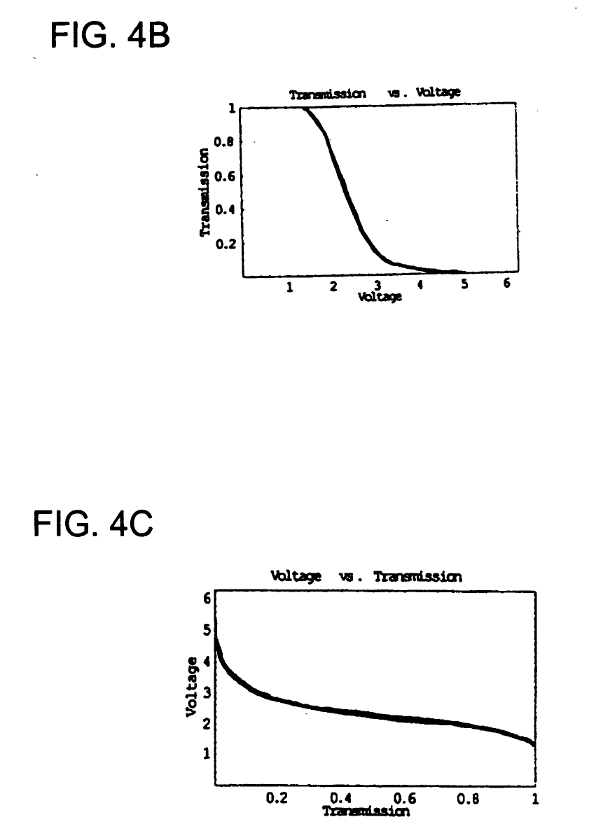

Measured EO response curves can be used to select a DATARAMP waveform. For multi-color displays, a DATARAMP waveform is generally selected for each color channel, typically red, green, and blue color channels. For example, a measured EO response is shown in FIG. 4A. Transmission values for voltages less than the voltage that produces a maximum transmission are truncated as shown in FIG. 4B. The EO response of FIG. 4B can be inverted to produce a curve illustrating voltage as a function of transmission as shown in FIG. 4C. Based on the inverse curve of FIG. 4C, display gamma can be selected. For example, if a display with γ=1 is intended, the inverse curve can be used to directly generate the DATARAMP waveform. For other values of γ, the inverse curve is combined with a transfer function associated with the selected value of γ. For example, transfer function for γ=2.5 is shown in FIG. 4D. A composite function V(T(g)) based on the curves of FIGS. 4C-4D is shown in FIG. 4E. The composite function can be used to generate the DATARAMP waveform.

In a typical display using one or more LCDs, DATARAMP waveforms for the LCDs are generated by associated arbitrary waveform generators (AWGs) that use a digital to-analog converter to produce the DATARAMP waveform. Values associated with composite transfer functions such as the representative transfer function illustrated in FIG. 4E are provided to the AWGs so that appropriate DATARAMP voltages can be generated. Typically, a voltage generated by an AWG is a linear function of such input values.

Different LCD configurations can use other arrangements of the composite function. For example, if a maximum voltage is associated with a minimum transmittance, tabulated composite values can be reversed.

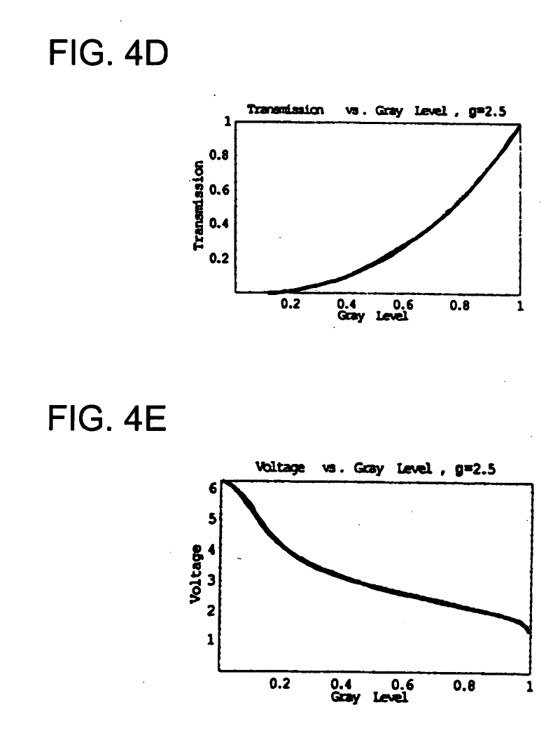

A representative display system using corrected values as described above is illustrated in FIG. 5. LCDs 502-504 are in communication with respective LCD drivers 506, 508, 510 that can provide, for example, DATARAMP waveforms and other electrical inputs to the LCDs. The LCD drivers 506, 508, 510 are in communication with respective memories 512, 514, 516 that are configured to receive EO response data or composite correction data. The LCD drivers 506, 508, 510 typically include waveform generators that produce DATARAMP waveforms based on the stored data. In addition, correction inputs 518, 520, 522 are provided and are configured to receive, for example, a selected value of display gamma, and composite data associated with the selected value of gamma can be produced by a processor and stored in the memories. Alternatively, sets of composite data for various values of gamma can be stored, so that generation of additional composite data is unnecessary.

While representative examples are described above, it will be apparent that these examples can be modified in arrangement and detail and details of the examples should not be taken to limit the scope of the appended claims.

1. A method of determining an electro-optic (EO) response of a liquid crystal display (LCD), comprising:
applying a predetermined video drive level to the LCD;
applying DataRamp waveforms having a plurality of amplitudes to the LCD; and
recording values of an optical property of the LCD associated with the plurality of DataRamp amplitudes.

2. The method of claim 1, wherein the recorded values are LCD transmission values.

3. The method of claim 1, further comprising establishing displayed gray level values based on the DataRamp amplitudes and the recorded transmission values.

4. A measurement system for determining LCD EO response, comprising:
an illuminator configured to direct an illumination beam to an LCD;
an optical receiver configured to receive the illumination beam from the LCD;
an LCD driver configured to apply a DataRamp waveform having a plurality of amplitudes to the LCD; and
a controller configured to record the DataRamp amplitudes in association with a corresponding LCD transmission value.

5. The measurement system of claim 4, wherein the controller is configured to determine an LCD transfer function based on the recorded DataRamp amplitudes and the associated LCD transmission values.

6. A display driver, comprising:
a video input configured to receive an image signal;
a memory configured to store a set of values associated with a composite transfer function; and
a DataRamp generator configured to produce a DataRamp waveform based on the composite transfer function values stored in the memory and to deliver the DataRamp waveform to a display.

7. The display driver of claim 6, further comprising:
an input configured to receive a gamma value;
a memory configured to store an LCD electro-optic response; and
a processor configured to produce composite transfer function values based on the stored electro-optic response and the gamma value.

8. A liquid crystal display system, comprising:
a liquid crystal display (LCD); and
the display driver of claim 6, wherein the display driver is configured to supply the DataRamp waveform to the LCD.

9. A liquid crystal display system, comprising:
a liquid crystal display (LCD); and
the display driver of claim 7, wherein the display driver is configured to supply the DataRamp waveform to the LCD.

10. A display processor, comprising:
a memory configured to store values associated with a composite transfer function for a liquid crystal display; and
a waveform generator configured to produce a data ramp waveform based on the stored values.

11. The display processor of claim 10, further comprising an input configured to receive an indication of a gamma correction value, wherein the memory is configured to store values associated with a gamma-corrected composite transfer function.

12. The display processor of claim 11, further comprising:
a gamma-selector configured to select a gamma value; and
a gamma correction processor configured to produce values associated with a gamma-corrected composite transfer function and direct the values to the memory.

13. The display processor of claim 12, wherein the memory is configured to store an LCD electro-optic (EO) response, and the gamma-corrected composite transfer function is based on the stored EO response.

14. A liquid crystal display system, comprising:
an active matrix liquid crystal display (LCD);
an optical system configured to display an image based on the active matrix LCD;
a memory configured to store a composite transfer function of the LCD;
a waveform generator configured to produce a data ramp waveform based on the stored composite transfer function.

15. The liquid crystal display system of claim 14, wherein the memory is configured to store an electro-optic response of the LCD, and further comprising a processor configured to generate composite transfer function values based on the stored electro-optic response.

16. The liquid crystal display system of claim 15, wherein the processor is configured to receive a value of gamma and to generate composite transfer function values based on the value of gamma.

17. The liquid crystal display of claim 14, further comprising LCDs associated with red, green, and blue color channels, and the memory is configured to store composite transfer functions associated with the red, green, and blue color channels, and the waveform generator is configured to product data ramp waveforms associated with the red, green, and blue color channels.

18. The liquid crystal display of claim 17, wherein the memory is configured to store electro-optic responses associated with the red, green, and blue color channels.

19. The liquid crystal display system of claim 17, wherein the processor is configured to receive a value of gamma and to generate composite transfer function values based on the value of gamma.

20. A display method, comprising:
obtaining an electro-optic response of an active matrix liquid crystal display; and
generating a data ramp waveform based on the electro-optic response.
